(19) United States
(12) Patent Application Publication
(10) Pub. No.: US 2020/0238709 A1
(43) Pub. Date: Jul. 30, 2020

(54) HEAD UNIT AND INKJET RECORDING APPARATUS

(71) Applicant: KYOCERA Document Solutions Inc., Osaka (JP)

(72) Inventors: Hiroyuki TOMIOKA, Osaka-shi (JP); Takuma ARAKI, Osaka-shi (JP)

(73) Assignee: KYOCERA Document Solutions Inc., Osaka (JP)

(21) Appl. No.: 16/749,831

(22) Filed: Jan. 22, 2020

(30) Foreign Application Priority Data
Jan. 24, 2019 (JP) 2019-010415

(51) Int. Cl. B41J 2/175

(52) U.S. Cl. CPC B41J 2/175

(57) ABSTRACT

A head unit includes a recording head, a pipe member, and an ink supply section. The recording head ejects an ink. The pipe member supplies the ink to the recording head. The ink supply section supplies the ink to the pipe member. The ink supply section includes a flow channel in which the ink flows to one end of the pipe member. A ceiling surface constituting a part of the flow channel inclines such that a height of the ceiling surface from a bottom surface constituting a part of the flow channel increases toward the one end of the pipe member.

### INCORPORATION BY REFERENCE

The present application claims priority under 35 U.S.C. § 119 to Japanese Patent Application No. 2019-010415, filed on Jan. 24, 2019. The contents of this application are incorporated herein by reference in their entirety.

### BACKGROUND

The present disclosure relates to a head unit and an inkjet recording apparatus.

An inkjet recording apparatus has a nozzle surface in which multiple nozzles are formed. The inkjet recording apparatus records an image on a recording medium by ejecting ink from all or some of the multiple nozzles. In a situation in which a bubble is present in a flow channel in which the ink flows, nozzle clogging may occur. Specifically, when a bubble flows by ink flow and reaches one of the nozzles, the bubble may inhibit ink ejection. Therefore, it is necessary to expel bubbles from the flow channel.

### SUMMARY

A head unit according to an aspect of the present disclosure includes a recording head, a pipe member, and an ink supply section. The recording head ejects an ink. The pipe member supplies the ink to the recording head. The ink supply section supplies the ink to the pipe member. The ink supply section includes a flow channel in which the ink flows to one end of the pipe member. A ceiling surface constituting a part of the flow channel inclines such that a height of the ceiling surface from a bottom surface constituting a part of the flow channel increases toward the one end of the pipe member.

An inkjet recording apparatus according to an aspect of the present disclosure includes the above-described head unit.

### BRIEF DESCRIPTION OF THE DRAWINGS

FIG. 1 is a perspective view of a head unit according to an embodiment of the present disclosure.

FIG. 2 is a perspective view of the head unit according to the embodiment of the present disclosure.

FIG. 3 is a perspective view of a dampening member according to the embodiment of the present disclosure.

FIG. 4 is a top view of the dampening member according to the embodiment of the present disclosure.

FIG. 5 is a cross-sectional view of the dampening member according to the embodiment of the present disclosure.

FIG. 6 is a diagram illustrating a configuration of an ink supply unit according to the embodiment of the present disclosure.

FIG. 7 is a diagram illustrating a configuration of an inkjet recording apparatus according to the embodiment of the present disclosure.

### DETAILED DESCRIPTION

The following describes an embodiment of the present disclosure with reference to the accompanying drawings. However, elements that are the same or equivalent are indicated by the same reference signs in the drawings and description thereof is not repeated. Note that some overlapping description may be omitted where appropriate. Although a front-back direction, an up-and-down direction, and a left-right direction are indicated in some drawings in order to facilitate understanding, these directions are not intended to limit orientations of a head unit and an inkjet recording apparatus according to the present disclosure during manufacture or use.

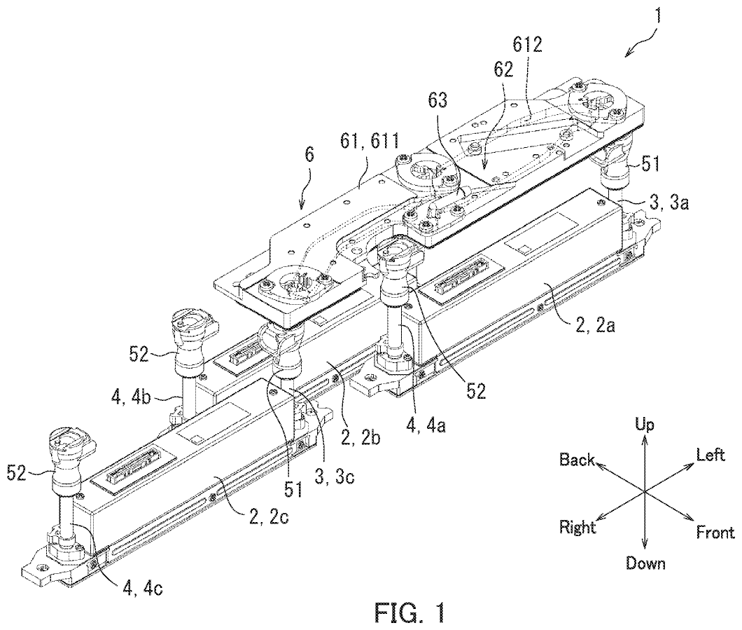

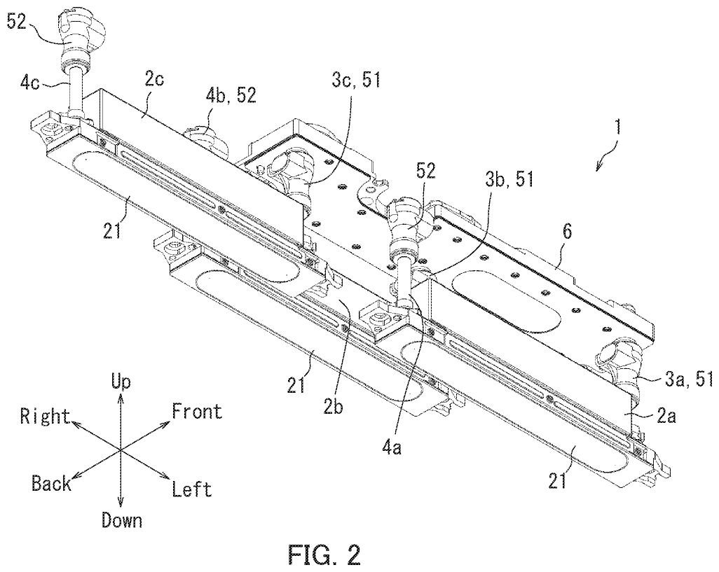

First, a head unit 1 according to the present embodiment will be described with reference to FIGS. 1 and 2. FIGS. 1 and 2 are each a perspective view of the head unit 1 according to the present embodiment. Specifically, FIG. 1 illustrates the head unit 1 as viewed obliquely downward from right front thereof. FIG. 2 illustrates the head unit 1 as viewed obliquely upward from right front thereof. As illustrated in FIGS. 1 and 2, the head unit 1 according to the present embodiment includes three recording heads 2, three supply pipe members 3, three circulation pipe members 4, a dampening member 6, three first coupling members 51, and three second coupling members 52.

The three recording heads 2 each eject ink. Specifically the three recording heads 2 eject ink of the same color. Each of the recording heads 2 extends in the left-right direction. In the present embodiment, the three recording heads 2 include a first recording head 2a, a second recording head 2b, and a third recording head 2c. The first to third recording heads 2a to 2c are arranged in a staggered manner in the left-right direction. Specifically, the second recording head 2b is arranged behind the first and third recording heads 2a and 2c.

The three recording heads 2 each have a nozzle surface 21 (see FIG. 2). Each of the recording heads 2 ejects the ink from a corresponding one of the nozzle surfaces 21. Specifically, multiple nozzle orifices are formed in the nozzle surface 21 and the ink is ejected from the nozzle orifices.

The three supply pipe members 3 supply the ink to the respective three recording heads 2. The three supply pipe members 3 each have one end (lower end) connected to a left end of a corresponding one of the recording heads 2. The three supply pipe members 3 extend upward from the respective recording heads 2. In the present embodiment, the three supply pipe members 3 include a first supply pipe member 3a, a second supply pipe member 3b, and a third supply pipe member 3c. The first supply pipe member 3a supplies the ink to the first recording head 2a. The second supply pipe member 3b supplies the ink to the second recording head 2b (see FIG. 2). The third supply pipe member 3c supplies the ink to the third recording head 2c.

The three circulation pipe members 4 each have one end (lower end) connected to a right end of a corresponding one of the recording heads 2. The three circulation pipe members 4 extend upward from the respective recording heads 2. In the present embodiment, the three circulation pipe members 4 include a first circulation pipe member 4a, a second circulation pipe member 4b, and a third circulation pipe member 4c. The first circulation pipe member 4a is connected to the first recording head 2a. The second circulation pipe member 4b is connected to the second recording head 2b. The third circulation pipe member 4c is connected to the third recording head 2c.

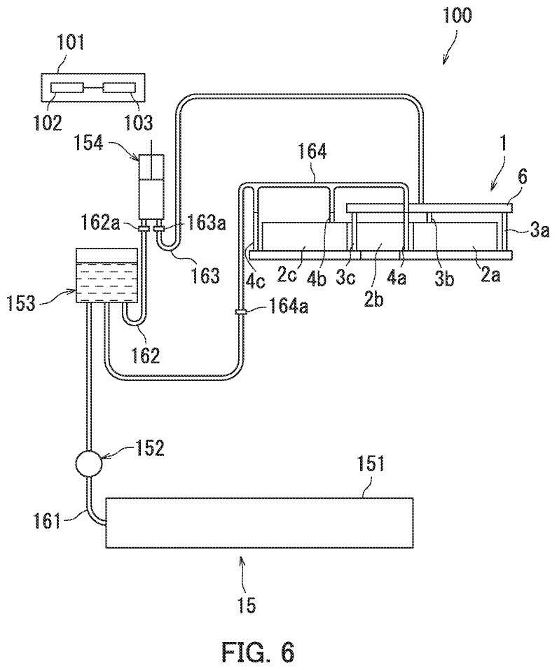

The ink flows into each of the circulation pipe members 4 from a corresponding one of the recording heads 2 in a purge operation. The purge operation is an operation to supply ink to the recording heads 2 by applying pressure to the ink to a degree at which the ink is not ejected from the nozzle orifices. The purge operation is executed for the purpose to expel bubbles from the ink, for example. When the purge operation is executed, the ink is discharged from each of the three recording heads 2 to a corresponding one of the circulation pipe members 4. Specifically, the ink flowing in the recording heads 2 from the supply pipe members 3 flows into the circulation pipe members 4 through circulation channels established inside the respective recording heads 2. In so doing, bubbles flow into the recording heads 2 together with the ink from the supply pipe members 3. The bubbles flow together with the ink into the circulation pipe members 4 through the circulation channels. The bubbles and the ink flowing in the circulation pipe members 4 return to an ink supply unit 15, which will be described later with reference to FIG. 6.

The dampening member 6 is disposed above the three recording heads 2. The dampening member 6 supplies the ink to the three supply pipe members 3. The ink is accordingly supplied to the three recording heads 2 through the respective three supply pipe members 3. The dampening member 6 is an example of an ink supply section.

The three first coupling members 51 each connect the other end (upper end) of a corresponding one of the three supply pipe members 3 to the dampening member 6. The three second coupling members 52 each connect the other end (upper end) of a corresponding one of the three circulation pipe members 4 to a circulation pipe 164, which will be described later with reference to FIG. 6.

The dampening member 6 of the present embodiment will be described next with reference to FIG. 1. As illustrated in FIG. 1, the dampening member 6 includes a base 61, a flow channel 62, and an ink flow-in portion 63.

The base 61 is a plate-shaped member. The base 61 extends in the left-right direction. In other words, the base 61 extends in a direction in which the three recording heads 2 are arranged. The base 61 includes an upper wall 611.

The ink flow-in portion 63 is located in the upper wall 611 of the base 61. The ink flow-in portion 63 is located in a substantial center of the base 61 in the left-right direction. The ink is supplied to the ink flow-in portion 63 from the ink supply unit 15, which will be described with reference to FIG. 6.

The flow channel 62 is established inside the base 61. The base 61 includes an inner wall 612 there inside that constitutes a side surface of the flow channel 62. The ink flows into the flow channel 62 from the ink flow-in portion 63. The flow channel 62 guides the ink to the respective other ends (upper ends) of the three supply pipe members 3. Note that a part of the upper wall 611 of the base 61 constitutes a ceiling surface of the flow channel 62.

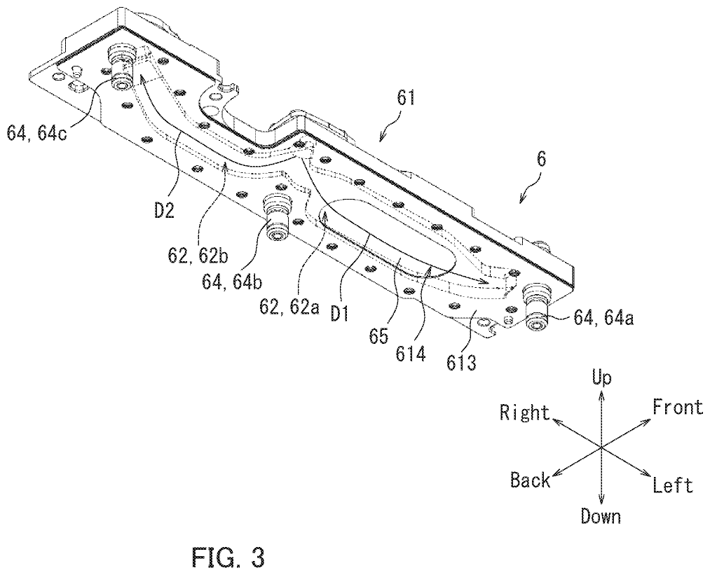

The dampening member 6 of the present embodiment will be further described with reference to FIG. 3. FIG. 3 is a perspective view of the dampening member 6 in the present embodiment. Specifically, FIG. 3 illustrates the dampening member 6 as viewed obliquely upward from right front thereof. As illustrated in FIG. 3, the base 61 includes a lower wall 613. A part of the lower wall 613 of the base 61 constitutes a bottom surface of the flow channel 62. The dampening member 6 includes three ink flow-out portions 64 in the lower wall 613 of the base 61.

The three ink flow-out portions 64 each protrude downward from the lower wall 316 of the base 61. The three ink flow-out portions 64 each communicate with the other end (upper end) of a corresponding one of the three supply pipe members 3 described with reference to FIGS. 1 and 2. The dampening member 6 supplies the ink to the three supply pipe members 3 by allowing the ink to flow thereinto from the three ink flow-out portions 64.

Specifically, the three ink flow-out portions 64 are connected to the other ends of the three supply pipe members 3 by means of the respective three first coupling members 51 described with reference to FIGS. 1 and 2. The three ink flow-out portions 64 include a first ink flow-out portion 64a, a second ink flow-out portion 64b, and a third ink flow-out portion 64c in the present embodiment. The first ink flow-out portion 64a is connected to the other end of the first supply pipe member 3a by means of one of the three first coupling members 51. In the above configuration, the ink is supplied from the first ink flow-out portion 64a to the first supply pipe member 3a. The second ink flow-out portion 64b is connected to the other end of the second supply pipe member 3b by means of another one of the three first coupling members 51. In the above configuration, the ink is supplied from the second ink flow-out portion 64b to the second supply pipe member 3b. The third ink flow-out portion 64c is connected to the other end of the third supply pipe member 3c by means of the other of the three first coupling members 51. In the above configuration, the ink is supplied from the third ink flow-out portion 64c to the third supply pipe member 3c.

As illustrated in FIG. 3, the flow channel 62 includes a first flow channel 62a and a second flow channel 62b. Specifically, the flow channel 62 extends in the left-right direction. The first flow channel 62a is a portion of the flow channel 62 located left of a substantial center of the flow channel 62 in the left-right direction. The second flow channel 62b is a portion of the flow channel 62 located right of the substantial center of the flow channel 62 in the left-right direction. One end of the first flow channel 62a communicates with an upper end opening of the first ink flow-out portion 64a. One end of the second flow channel 62b communicates with an upper end opening of the third ink flow-out portion 64c. In the following description, the substantial center of the flow channel 62 in the left-right direction may be referred to as a “center of the flow channel 62”.

The ink supplied to the ink flow-in portion 63 described with reference to FIG. 1 flows out to the center of the flow channel 62 from the ink flow-in portion 63. A portion of the ink flowing out from the ink flow-in portion 63 to the flow channel 62 flows along the first flow channel 62a. Another portion of the ink flowing out from the ink flow-in portion 63 to the flow channel 62 flows along the second flow channel 62b. The remaining portion of the ink flowing out from the ink flow-in portion 63 to the flow channel 62 flows into an upper end opening of the second ink flow-out portion 64b via the flow channel 62.

The ink flowing in the first flow channel 62a flows into the upper end opening of the first ink flow-out portion 64a in a first flow direction D1. The ink flowing in the second flow channel 62b flows into the upper end opening of the third ink flow-out portion 64c in a second flow direction D2. In the above configuration, the ink flows from the first flow channel 62a into the first ink flow-out portion 64a, thereby being supplied to the first recording head 2a described with reference to FIGS. 1 and 2. Likewise, the ink flows from the second flow channel 62b into the third ink flow-out portion 64c, thereby being supplied to the third recording head 2c described with reference to FIGS. 1 and 2.

As illustrated in FIG. 3, the lower wall 613 of the base 61 has an opening 614. The opening 614 opens toward the first flow channel 62a. The dampening member 6 further includes a film 65 covering the opening 614. The film 65 extends along the flow channel 62. In detail, the film 65 constitutes a part of the bottom surface of the flow channel 62. Specifically, the film 65 constitutes a part of a bottom surface of the first flow channel 62a. The film 65 is an example of a thin film member.

The film 65 is elastic. The film 65 includes for example a polyethylene terephthalate (PET) film as a base material. As a result of the film 65 constituting a part of a plane that constitutes the flow channel 62, pressure variation of the ink can be absorbed by the film 65. In other words, an amount of variation in ink pressure can be reduced by the film 65. Specifically, the film 65 expands and contracts according to variation in ink pressure. As a result, variation in ink pressure is absorbed. Note that no particular limitations are placed on the length of the film 65 along the flow channel 62 as long as variation in ink pressure can be absorbed.

Variation in ink pressure may serve as a cause of ink dripping from a nozzle in suspension of ink ejection. Variation in ink pressure may also serve as a cause of the ink flowing in at least one of the three circulation pipe members 4 described with reference to FIGS. 1 and 2 in suspension of ink ejection.

Specifically, the recording heads 2 eject the ink according to a to-be-recorded image. In detail, the image includes a print portion and a non-print portion. The recording heads 2 perform ink ejection for the print portion while suspending ink ejection for the non-print portion. Variation in ink pressure occurs upon ink ejection being suspended for the non-print portion. More specifically, the recording heads 2 each include a piezoelectric element. Driving of the piezoelectric element ejects the ink. Suspension of driving of the piezoelectric element causes suspension of ink ejection. Variation in ink pressure occurs due to suspension of driving of the piezoelectric element.

According to the present embodiment, the film 65 absorbs variation in ink pressure. Therefore, it is difficult for the ink to drip from the nozzles during suspension of ink ejection. Furthermore, it is difficult for the ink to flow into the three circulation pipe members 4 described with reference to FIGS. 1 and 2 in suspension of ink ejection.

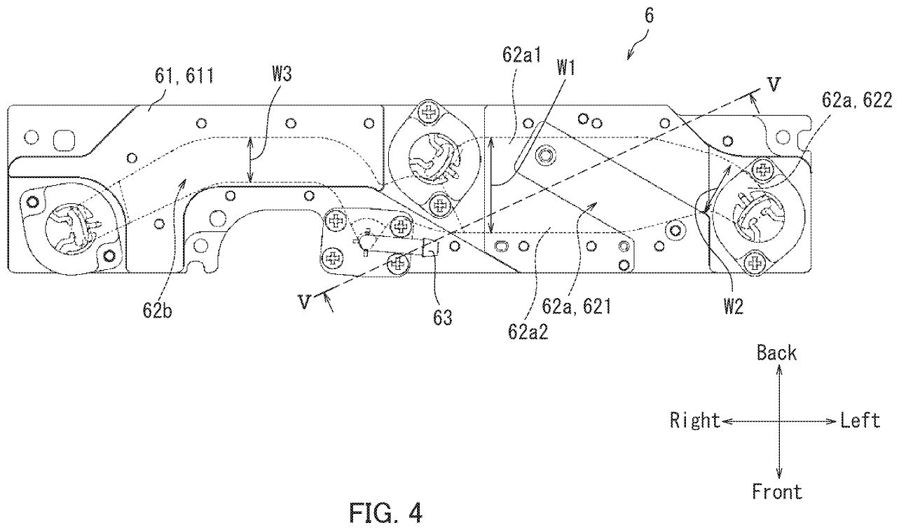

The dampening member 6 of the present embodiment will be further described with reference to FIG. 4. FIG. 4 is a top view of the dampening member 6 in the present embodiment. As illustrated in FIG. 4, the first flow channel 62a includes a wide portion 621 and a narrow portion 622.

The narrow portion 622 is located on a side of the first ink flow-out portion 64a described with reference to FIG. 3. In other words, the narrow portion 622 is located on a side of the first supply pipe member 3a described with reference to FIGS. 1 and 2. The wide portion 621 is connected to the narrow portion 622. In other words, the wide portion 621 and the narrow portion 622 communicate with each other. The wide portion 621 is located upstream of the narrow portion 622 in terms of a direction of ink flow.

The wide portion 621 has a width W1 wider than a width W2 of the narrow portion 622. In the above configuration, a flow channel sectional area of the wide portion 621 is larger than that of the narrow portion 622. Accordingly, a flow rate of the ink flowing in the wide portion 621 is slower than a flow rate of the ink flowing in the narrow portion 622. Therefore, bubbles tend to stay in the wide portion 621.

The film 65 described with reference to FIG. 3 extends along the wide portion 621. In other words, the film 65 constitutes a part of a bottom surface of the wide portion 621. In the above configuration, the film 65 absorbs variation in ink pressure at a location where the ink flows slowly. Thus, variation in ink pressure can be efficiently absorbed.

As illustrated in FIG. 4, the wide portion 621 has a first side end 62a1 and a second side end 62a2. The first side end 62a1 and the second side end 62a2 extends opposite to each other in a width direction of the flow channel 62.

The flow rate of the ink differs between along the first side end 62a1 and along the second side end 62a2 of the wide portion 621 in the present embodiment. Specifically, the flow rate of the ink flowing along the first side end 62a1 is faster than the flow rate of the ink flowing along the second side end 62a2. In other words, the flow rate of the ink flowing along the second side end 62a2 is slower than the flow rate of the ink flowing along the first side end 62a1. In the above configuration, bubbles tend to stay along the second side end 62a2 of the wide portion 621.

The second flow channel 62b has a width W3 narrower than the width W1 of the wide portion 621. In the above configuration, the flow rate of the ink is sufficiently fast and bubbles tend not to stay in the second flow channel 62b.

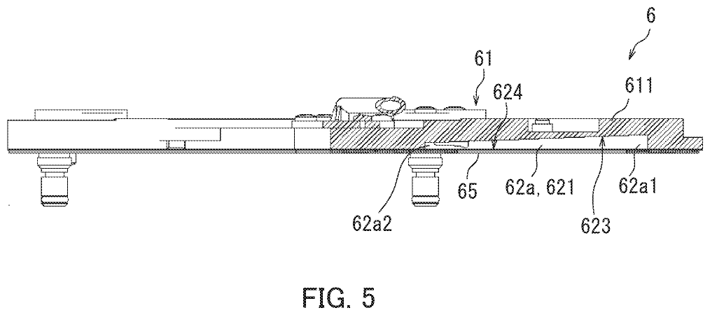

The dampening member 6 of the present embodiment will be further described with reference to FIGS. 4 and 5. FIG. 5 is a cross-sectional view of the dampening member 6 in the present embodiment. Specifically, FIG. 5 illustrates a section taken along a line V-V in FIG. 4.

As illustrated in FIG. 5, the first flow channel 62a has a ceiling surface 623 and a floor surface 624. FIG. 5 illustrates the ceiling surface 623 and the floor surface 624 in the wide portion 621. As illustrated in FIGS. 4 and 5, the ceiling surface 623 of the first flow channel 62a inclines such that a height of the ceiling surface 623 from a bottom surface 624 of the first flow channel 62a increases toward the upper end opening of the first ink flow-out portion 64a described with reference to FIG. 3. In other words, the ceiling surface 623 of the first flow channel 62a inclines such that the height of the ceiling surface 623 from the bottom surface 624 of the first flow channel 62a increases toward the one end (upper end) of the first supply pipe member 3a described with reference to FIGS. 1 and 2.

The head unit 1 according to the present embodiment has been described so far with reference to FIGS. 1 and 5. According to the present embodiment, bubbles can be efficiently expelled from the first flow channel 62a. Specifically, bubbles present in the ink, which have a slammer specific gravity than the ink, moves upward. Therefore, the bubbles gather on the ceiling surface 623. In the present embodiment, the ceiling surface 623 of the first flow channel 62a inclines such that the height of the ceiling surface 623 from the bottom surface 624 of the first flow channel 62a increases toward the one end (upper end) of the first supply pipe member 3a, thereby allowing the bubbles to flow from the wide portion 621 toward the narrow portion 622. The flow rate of the ink flowing along the narrow portion 622 is fast, and the bubbles reaching the narrow portion 622 flow into the first supply pipe member 3a together with the ink. Accordingly, bubbles can be efficiently expelled from the first flow channel 62a in the present embodiment.

The dampening member 6 of the present embodiment will be further described with reference to FIGS. 4 and 5. As illustrated in FIGS. 4 and 5, the ceiling surface 623 in the wide portion 621 inclines such that the height of the ceiling surface 623 from the bottom surface 624 in the wide portion 621 increases toward the first side end 62a1. In the above configuration, bubbles move from the second side end 62a2, along which the ink flows at a slow flow rate, toward the first side end 62a1, along which the ink flows at a fast flow rate. Accordingly, the bubbles are difficult to stay in the narrow portion 622, resulting in efficient expelling of bubbles from the first flow channel 62a.

Next, an inclination angle of the ceiling surface 623 will be described. The inclination angle of the ceiling surface 623 in the present embodiment is set such that the height of the ceiling surface 623 from the bottom surface 624 increases toward the one end (upper end) of the first supply pipe member 3a even in a situation in which an inkjet recording apparatus 100 including the head unit 1 is installed at a maximum installation angle. In other words, the ceiling surface 623 in the present embodiment inclines relative to a horizontal plane even in a situation in which the inkjet recording apparatus 100 is installed at the maximum installation angle. Therefore, bubbles can be expelled from the first flow channel 62a even in a situation in which the inkjet recording apparatus 100 is installed at the maximum installation angle in the present embodiment. Note that the installation angle herein means an inclination angle of an installation plane where the inkjet recording apparatus 100 is installed relative to the horizontal plane and the maximum installation angle means a maximum installation angle at which the inkjet recording apparatus 100 is installable.

The inkjet recording apparatus 100 according to the present embodiment will be described next with reference to FIG. 6. FIG. 6 is a diagram illustrating a configuration of the ink supply unit 15 according to the present embodiment.

As illustrated in FIG. 6, the inkjet recording apparatus 100 includes the head unit 1, the ink supply unit 15, and a controller 101. The ink supply unit 15 supplies the ink to the dampening member 6. Specifically, the ink supply unit 15 supplies the ink to the ink flow-in portion 63 described with reference to FIG. 1. The controller 101 controls the ink supply unit 15. The controller 101 further controls the three recording heads 2.

The ink supply unit 15 in the present embodiment includes an ink tank 151, a supply pump 152, a sub tank 153, a syringe pump 154, a first pipe 161, a second pipe 162, a third pipe 163, a circulation pipe 164, a first valve 162a, a second valve 163a, and a circulation valve 164a.

The ink tank 151 contains the ink. The ink tank 151 is connected to the sub tank 153 through the first pipe 161. The first pipe 161 allows the ink to flow from the ink tank 151 to the sub tank 153. The sub tank 153 reserves the ink supplied from the ink tank 151. The sub tank 153 is connected to the syringe pump 154 through the second pipe 162. The second pipe 162 allows the ink to flow from the sub tank 153 to the syringe pump 154. The syringe pump 154 is connected to the dampening member 6 (the ink flow-in portion 63) through the third pipe 163. The third pipe 163 allows the ink to flow from the syringe pump 154 to the dampening member 6 (the ink flow-in portion 63).

The supply pump 152 is disposed in the first pipe 161. The supply pump 152 supplies the ink reserved in the ink tank 151 to the sub tank 153 according to an instruction from the controller 101.

The syringe pump 154 sucks the ink reserved in the sub tank 153 through the second pipe 162. The syringe pump 154 ejects the ink sucked from the sub tank 153 to the third pipe 163. Specifically, the syringe pump 154 includes a cylinder and a piston. The cylinder reserves therein the ink sucked from the sub tank 153. The cylinder is for example cylindrical in shape. An inlet and an outlet are located in the bottom of the cylinder. The inlet is connected to the second pipe 162. The outlet is connected to the third pipe 163.

The piston is inserted in the cylinder. The piston moves away from the bottom of the cylinder according to an instruction from the controller 101. Also, the piston moves toward the bottom of the cylinder according to an instruction from the controller 101.

When the piston moves away from the bottom of the cylinder, the ink is sucked into the cylinder. Specifically, the ink flows out from the sub tank 153 into the second pipe 162 and further flows into the cylinder through the second pipe 162.

When the piston moves toward the bottom of the cylinder, the ink flows out from the cylinder into the third pipe 163 and further flows into the dampening member 6 (the ink flow-in portion 63) through the third pipe 163.

Furthermore, in execution of the purge operation described with reference to FIG. 1, the piston moves toward the bottom of the cylinder such that the ink is supplied to the dampening member 6 (the ink flow-in portion 63) at a pressure at which no ink ejection from the three nozzle surfaces 21 is caused. Specifically, the controller 101 controls moving speed of the piston so that the ink is supplied to the dampening member 6 (the ink flow-in portion 63) at a pressure at which no ink ejection from the three nozzle surfaces 21 is caused.

The first valve 162a is disposed in the second pipe 162. The second valve 163a is disposed in the third pipe 163. The first valve 162a and the second valve 163a are each opened or closed according to an instruction from the controller 101. Specifically, during the piston moving away from the bottom of the cylinder, the first valve 162a is open while the second valve 163a is closed. By contrast, during the piston moving toward the bottom of the cylinder, the first valve 162a is closed while the second valve 163a is open.

The circulation pipe 164 allows communication between the sub tank 153 and the three circulation pipe members 4 described with reference to FIG. 1. Specifically, as described with reference to FIG. 1, the other ends (upper ends) of the three circulation pipe members 4 are each connected to the circulation pipe 164 by means of a corresponding one of the three second coupling members 52. The circulation pipe 164 allows bubbles and the ink flowing out from the three recording heads 2 (the three circulation pipe members 4) to flow into the sub tank 153 in execution of the purge operation. The sub tank 153 has a through hole. The through hole communicates with the atmosphere. The through hole is located above the liquid surface of the ink reserved in the sub tank 153. In the above configuration, the bubbles expelled from the head unit 1 to the sub tank 153 by the purge operation are expelled to the atmosphere though the through hole of the sub tank 153.

The circulation valve 164a is disposed in the circulation pipe 164. The circulation valve 164a is opened or closed according to an instruction from the controller 101. Specifically, the circulation valve 164a is open during execution of the purge operation and is closed during image recording.

The controller 101 includes storage 102 and a processing device 103. The storage 102 stores data and a program therein. The storage 102 includes for example semiconductor memory such as random access memory (RAM) or read-only memory. The storage 102 may further include a storage device such as a hard disk drive (HDD). The processing device 103 includes a processor such as a central processing unit (CPU) or a micro-processing unit (MPU). The processing device 103 controls operation of each element of the inkjet recording apparatus 100 based on the program stored in the storage 102.

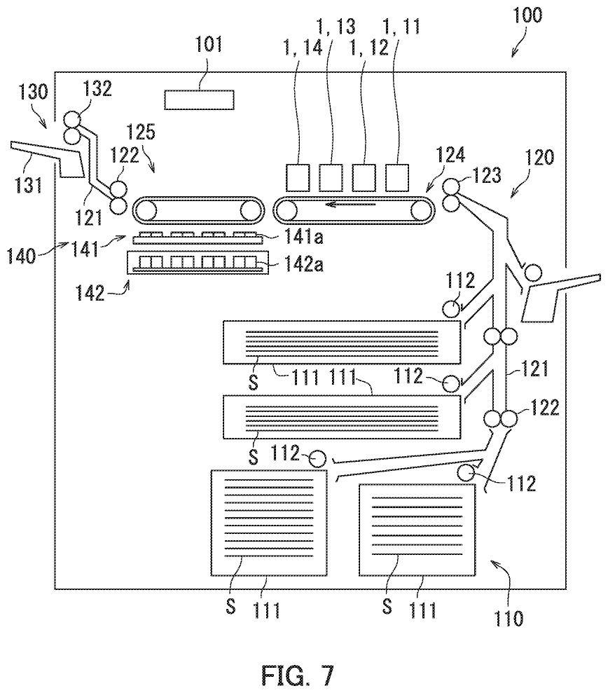

The inkjet recording apparatus 100 according to the present embodiment will be further described with reference to FIG. 7. FIG. 7 is a diagram illustrating a configuration of the inkjet recording apparatus 100 according to the present embodiment.

As illustrated in FIG. 7, the inkjet recording apparatus 100 includes a feeding section 110, a sheet conveyance section 120, an ejection section 130, and a maintenance unit 140. The inkjet recording apparatus 100 further includes four head units 1.

The feeding section 110 feeds a sheet S to the sheet conveyance section 120. The feeding section 110 in the present embodiment includes a plurality of accommodation cassettes 111 and a plurality of feeding rollers 112. The accommodation cassettes 111 each accommodate at least one sheet S. The feeding rollers 112 each feed the sheet S from a corresponding one of the accommodation cassettes 111 to the sheet conveyance section 120. Note that the sheet S is an example of a recording medium.

The sheet conveyance section 120 conveys the sheet S to the ejection section 130. Specifically, the sheet conveyance section 120 includes a plurality of conveyance guides 121, a plurality of conveyance roller pairs 122, and a registration roller pair 123. The conveyance guides 121 constitute a conveyance path for the sheet S. The conveyance roller pairs 122 convey the sheet S along the conveyance path. The registration roller pair 123 adjusts conveyance timing for the sheet S to be conveyed to a region where the sheet S is to face the four head units 1.

The sheet conveyance section 120 in the present embodiment includes a first conveyance unit 124 and a second conveyance unit 125. The first conveyance unit 124 is disposed opposite to the four head units 1. The first conveyance unit 124 conveys the sheet S in a region directly below the four head units 1. The second conveyance unit 125 conveys the sheet S fed from the first conveyance unit 124 to the ejection section 130.

The three recording heads 2 provided in each of the four head units 1 eject inks toward the sheet S being conveyed by the first conveyance unit 124. Specifically, the four head units 1 eject inks different from one another in color. In the present embodiment, the four head units 1 include a first head unit 11, a second head unit 12, a third head unit 13, and a fourth head unit 14. For example, the three recording heads 2 of the first head unit 11 eject a black ink. The three recording heads 2 of the second head unit 12 eject a cyan ink. The three recording heads 2 of the third head unit 13 eject a magenta ink. The three recording heads 2 of the fourth head unit 14 eject a yellow ink.

The inkjet recording apparatus 100 includes four ink supply units 15, which are described with reference to FIG. 6. Ink tanks 151 of the four ink supply units 15 contain respective inks different from one another in color. Specifically, the four ink supply units 15 includes a first ink supply unit, a second ink supply unit, a third ink supply unit, and a fourth ink supply unit. For example, the first ink supply unit supplies the black ink to the dampening member 6 of the first head unit 11. The second ink supply unit supplies the cyan ink to the dampening member 6 of the second head unit 12. The third ink supply unit supplies the magenta ink to the dampening member 6 of the third head unit 13. The fourth ink supply unit supplies the yellow ink to the dampening member 6 of the fourth head unit 14.

The ejection section 130 ejects the sheet S out of the inkjet recording apparatus 100. The ejection section 130 in the present embodiment includes an exit tray 131 and an ejection roller pair 132. The ejection roller pair 132 ejects the sheet S onto the exit tray 131.

The maintenance unit 140 performs maintenance on the three recording heads 2 of each of the first to fourth head units 11 to 14. The maintenance unit 140 is positioned below the second conveyance unit 125 in image recording on the sheet S and moves to a location directly below the first to fourth head units 11 to 14 in maintenance on the recording heads 2. Note that the first conveyance unit 124 is moved to a retraction position during maintenance on the recording heads 2. The retraction position is a position where the first conveyance unit 124 does not collide with the maintenance unit 140.

The maintenance unit 140 in the present embodiment includes a capping section 141 and a cleaner 142. As described with reference to FIG. 2, each recording head 2 has the nozzle surface 21. The capping section 141 includes 12 capping members 141a. The 12 capping members 141a each cap the nozzle surface 21 of a corresponding one of the recording heads 2 to provide an environment in which the inks are difficult to be dried.

The cleaner 142 cleans the nozzle surface 21 of each recording head 2. Specifically, the cleaner 142 includes 12 wiping blades 142a. The wiping blades 142a are made from resin as a material, for example. The wiping blades 142a are cleaning members that clean the respective nozzle surfaces 21. The cleaner 142 wipes ink adhering to the nozzle surface of each of the recording heads 2 using a corresponding one of the wiping blades 142a.

An embodiment of the present disclosure has been described so far with reference to FIGS. 1 to 7. However, the present disclosure is not limited to the above-described embodiment and can be practiced in various ways within the scope without departing from the essence of the present disclosure. Furthermore, the elements of configuration disclosed in the above-described embodiment can be altered as appropriate. The drawings schematically illustrate elements of configuration in order to facilitate understanding of the present disclosure. Aspects such as thickness, length, and the number of the elements of configuration illustrated in the drawings may differ from actual aspects thereof in order to facilitate preparation of the drawings. Furthermore, configurations of the elements of configuration described in the above embodiment are merely examples and are not intended as specific limitations. Various alterations may be made so long as there is no substantial deviation from the effects of the present disclosure.

For example, the ceiling surface 623 of only the first flow channel 62a of the first and second flow channels 62a and 62b is inclined in the embodiment of the present disclosure. However, the ceiling surfaces of both the first and second flow channels 62a and 62b may be inclined.

Furthermore, the dampening member 6 includes one film 65 in the embodiment of the present disclosure. However, the dampening member 6 may include two or more films 65. For example, the dampening member 6 may include two films 65. In the above configuration, it is possible that one of the two films 65 extends along the first flow channel 62a while the other of the two films 65 extends along the second flow channel 62b.

Only the first flow channel 62a of the first and second flow channels 62a and 62b has the wide portion 621 in the embodiment of the present disclosure. However, the first and second flow channels 62a and 62b may each have the wide portion 621. Alternatively, only the second flow channel 62b may have the wide portion 621.

The head units 1 each include one dampening member 6 in the embodiment of the present disclosure. However, each head unit 1 may include two or more dampening members 6. For example, each head unit 1 may include three dampening members 6. In the above configuration, the dampening members 6 each supply the ink to a corresponding one of the recording heads 2.

The inkjet recording apparatus 100 according to the embodiment of the present disclosure includes four head units 1 but may include one, two, or three head units 1 or five or more head units 1.

The head units 1 in the embodiment of the present disclosure each include three recording head 2. However, each head unit 1 may include one or two recording heads 2 or four or more recording heads 2.

What is claimed is:

1. A head unit comprising:
a recording head configured to eject an ink;
a pipe member configured to supply the ink to the recording head; and
an ink supply section configured to supply the ink to the pipe member, wherein
the ink supply section includes a flow channel in which the ink flows to one end of the pipe member, and
a ceiling surface constituting a part of the flow channel inclines such that a height of the ceiling surface from a bottom surface constituting a part of the flow channel increases toward the one end of the pipe member.

2. The head unit according to claim 1, wherein
the flow channel has:
a narrow portion located close to the pipe member; and
a wide portion having a width wider than a width of the narrow portion,
the wide portion has a first side end and a second side end that are opposite to each other in a width direction of the flow channel,
a flow rate of the ink flowing along the first side end is faster than a flow rate of the ink flowing along the second side end, and
the ceiling surface of the flow channel inclines in the wide portion such that a height of the ceiling surface from the bottom surface increases toward the first side end.

3. The head unit according to claim 1, wherein
the ink supply section includes a thin film member, and
the thin film member constitutes a part of a plane constituting the flow channel.

4. The head unit according to claim 2, wherein
the ink supply section includes a thin film member, and
the thin film member constitutes a part of a plane constituting the wide portion of the flow channel.

5. The head unit according to claim 1, comprising:
as the recording head, a plurality of recording heads; and
as the pipe member, a plurality of pipe members for each of the recording heads, wherein
the flow channel allows the ink to flow to the one end of each of at least one of the pipe members.

6. An inkjet recording apparatus comprising
the head unit according to claim 1.

7. The inkjet recording apparatus according to claim 6, further comprising:
an ink supply unit configured to supply the ink to the ink supply section; and
a controller configured to control operation of the ink supply unit, wherein
the ink supply unit includes a circulation pipe into which the ink discharged from the recording head flows, and
the controller controls operation of the ink supply unit such that the ink is discharged from the recording head to the circulation pipe.
